(19) United States
(12) Patent Application Publication
(10) Pub. No.: US 2026/0196546 A1
(43) Pub. Date: Jul. 9, 2026

(54) COMPOSITE MEMBER, ELECTROCHEMICAL CELL, ELECTROCHEMICAL CELL DEVICE, MODULE, AND MODULE HOUSING DEVICE

(71) Applicant: KYOCERA Corporation, Kyoto-shi, Kyoto (JP)

(72) Inventors: Mankichi HOSODA, Kyotanabe-shi, Kyoto (JP); Akihiro HARA, Kirishima-shi, Kagoshima (JP)

(21) Appl. No.: 19/134,067

(22) PCT Filed: Nov. 24, 2023
(86) PCT No.: PCT/JP2023/042244

§ 371 Date: May 29, 2025

(30) Foreign Application Priority Data
Nov. 30, 2022 (JP) 2022-192031

(51) Int. Cl. H01M 8/1213; H01M 8/12; H01M 8/1253; H01M 8/2428

(52) U.S. Cl. CPC H01M 8/1213; H01M 8/1253; H01M 8/2428; H01M 2008/1293; H01M 2300/0077

(57) ABSTRACT

The composite member includes a polycrystalline first member, a second member, and a boundary portion. The first member contains a first material. The second member contains a second material different from the first material. The boundary portion is located between the first member and the second member and containing the first material and the second material. The boundary portion includes a first portion and a second portion. The second portion is thicker than the first portion.

### TECHNICAL FIELD

The present disclosure relates to a composite member, an electrochemical cell, an electrochemical cell device, a module, and a module housing device.

### BACKGROUND OF INVENTION

In recent years, various fuel cell stack devices each including a plurality of fuel cells have been proposed, as next-generation energy. A fuel cell is a type of electrochemical cell capable of obtaining electrical power by using a fuel gas such as a hydrogen-containing gas and an oxygen-containing gas such as air.

### CITATION LIST

### Patent Literature

Patent Document 1: JP 2016-81718 A
Patent Document 2: JP 2013-41809 A
Patent Document 3: JP 2012-23017 A

### SUMMARY

A composite member according to an aspect of an embodiment includes a polycrystalline first member, a second member, and a boundary portion. The first member contains a first material. The second member contains a second material different from the first material. The boundary portion is located between the first member and the second member and contains the first material and the second material. The boundary portion includes a first portion and a second portion. The second portion is thicker than the first portion.

An electrochemical cell of the present disclosure includes a composite member described above, and a first electrode layer and a second electrode layer facing each other across the composite member.

An electrochemical cell device of the present disclosure includes a cell stack including the electrochemical cell described above.

A module of the present disclosure includes the electrochemical cell device described above and a storage container housing the electrochemical cell device.

A module housing device of the present disclosure includes the module described above, an auxiliary device configured to operate the module, and an external case housing the module and the auxiliary device.

### BRIEF DESCRIPTION OF THE DRAWINGS

FIG. 1A is a horizontal cross-sectional view illustrating an example of an electrochemical cell according to a first embodiment.

FIG. 1B is a side view of an example of the electrochemical cell according to the first embodiment when viewed from the side of an air electrode layer.

FIG. 1C is a side view of an example of the electrochemical cell according to the first embodiment when viewed from the side of an interconnector.

FIG. 2A is a perspective view illustrating an example of an electrochemical cell device according to the first embodiment.

FIG. 2B is a cross-sectional view taken along a line X-X illustrated in FIG. 2A.

FIG. 2C is a top view illustrating an example of the electrochemical cell device according to the first embodiment.

FIG. 3 is a cross-sectional view illustrating an example of the vicinity of the boundary portion illustrated in FIG. 1A.

FIG. 4A is a plan view illustrating an example of the boundary portion illustrated in FIG. 3.

FIG. 4B is a plan view illustrating an example of the boundary portion illustrated in FIG. 3.

FIG. 5 is an exterior perspective view illustrating an example of a module according to the first embodiment.

FIG. 6 is an exploded perspective view schematically illustrating an example of a module housing device according to the first embodiment.

FIG. 7A is a cross-sectional view illustrating an example of an electrochemical cell device according to a second embodiment.

FIG. 7B is a horizontal cross-sectional view illustrating the electrochemical cell according to the second embodiment.

FIG. 8 is a cross-sectional view illustrating an example of the vicinity of the boundary portion illustrated in FIG. 7B.

FIG. 9 is a perspective view illustrating an example of an electrochemical cell according to a third embodiment.

FIG. 10 is a partial cross-sectional view of the electrochemical cell illustrated in FIG. 9.

FIG. 11 is a cross-sectional view illustrating an example of the vicinity of the boundary portion illustrated in FIG. 10.

FIG. 12A is a horizontal cross-sectional view illustrating an example of an electrochemical cell according to a fourth embodiment.

FIG. 12B is a horizontal cross-sectional view illustrating another example of the electrochemical cell according to the fourth embodiment.

FIG. 12C is a horizontal cross-sectional view illustrating another example of the electrochemical cell according to the fourth embodiment.

FIG. 13 is a cross-sectional view illustrating another example of the vicinity of the boundary portion illustrated in FIG. 12A.

### DESCRIPTION OF EMBODIMENTS

The fuel cell stack device mentioned above has room for improvement in increasing durability.

Provision of a composite member, an electrochemical cell, an electrochemical cell device, a module, and a module housing device that can improve durability is desired.

Embodiments of a composite member, an electrochemical cell, an electrochemical cell device, a module, and a module housing device disclosed in the present application will be described in detail below with reference to the accompanying drawings. Note that the disclosure is not limited by the following embodiments.

Note that the drawings are schematic and that the dimensional relationships between elements, the proportions of the elements, and the like may differ from the actual ones. There may be differences between the drawings in the dimensional relationships, proportions, and the like.

### First Embodiment

### Configuration of Electrochemical Cell

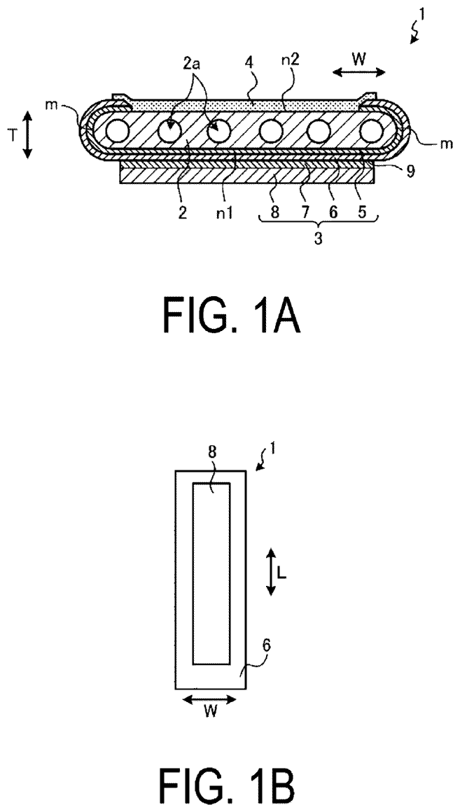

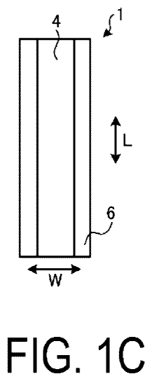

First, with reference to FIGS. 1A to 1C, an example of a solid oxide-type fuel cell will be described as an electrochemical cell according to a first embodiment. An electrochemical cell device may include a cell stack including a plurality of electrochemical cells. The electrochemical cell device including the plurality of electrochemical cells is simply referred to as a cell stack device.

FIG. 1A is a horizontal cross-sectional view illustrating an example of an electrochemical cell according to a first embodiment. FIG. 1B is a side view of an example of the electrochemical cell according to the first embodiment when viewed from the side of an air electrode. FIG. 1C is a side view of an example of the electrochemical cell according to the first embodiment when viewed from the side of an interconnector. Note that FIGS. 1A to 1C are enlarged views each illustrating part of a configuration of the electrochemical cell. Hereinafter, the electrochemical cell may be simply referred to as a cell.

In the example illustrated in FIGS. 1A to 1C, a cell 1 is of a hollow flat plate type, and has an elongated plate shape. As illustrated in FIG. 1B, the overall shape of the cell 1 when viewed from the side is, for example, a rectangle having a side length of from 5 cm to 50 cm in a length direction L and a length of from 1 cm to 10 cm in a width direction W orthogonal to the length direction L. The thickness in a thickness direction T of the entire cell 1 is, for example, from 1 mm to 5 mm.

As illustrated in FIG. 1A, the cell 1 includes a support substrate 2 having electrical conductivity, an element portion 3, and an interconnector 4. The support substrate 2 has a pillar shape having a first surface n1 and a second surface n2 which are a pair of flat surfaces facing each other, and a pair of circular arc-shaped side surfaces m that connect the first surface n1 and the second surface n2.

The element portion 3 is located on the first surface n1 of the support substrate 2. Such an element portion 3 includes a fuel electrode layer 5, a solid electrolyte layer 6, an intermediate layer 7, and an air electrode layer 8.

As illustrated in FIG. 1B, the air electrode layer 8 does not extend to the lower end of the cell 1. At the lower end portion of the cell 1, only the solid electrolyte layer 6 is exposed on a surface of the first surface n1. As illustrated in FIG. 1C, the interconnector 4 may extend to the lower end of the cell 1. At the lower end portion of the cell 1, the interconnector 4 and the solid electrolyte layer 6 are exposed on the surface. Note that, as illustrated in FIG. 1A, on the surface of the pair of the circular arc-shaped side surfaces m of the cell 1, the solid electrolyte layer 6 is exposed. The interconnector 4 need not extend to the lower end of the cell 1.

Hereinafter, each of the members constituting the cell 1 will be described.

The support substrate 2 includes gas-flow passages 2a, inside which gas flows. The example of the support substrate 2 illustrated in FIG. 1A includes six gas-flow passages 2a. The support substrate 2 has gas permeability and allows the fuel gas flowing through the gas-flow passages 2a to pass through to the fuel electrode layer 5. The support substrate 2 may have electrical conductivity. The support substrate 2 having electrical conductivity collects electricity generated in the element portion 3 to the interconnector 4.

The material of the support substrate 2 includes, for example, an iron group metal component and an inorganic oxide. For example, the iron group metal component may be Ni (nickel) and/or NiO. The inorganic oxide may be, for example, a specific rare earth element oxide. The rare earth element oxide may contain, for example, one or more rare earth elements selected from Sc, Y, La, Nd, Sm, Gd, Dy, and Yb.

As the material of the fuel electrode layer 5, a commonly known material may be used. As the fuel electrode layer 5, any of porous electrically conductive ceramics, for example, ceramics containing ZrO₂ in which a calcium oxide, a magnesium oxide, or a rare earth element oxide is in solid solution, and Ni and/or NiO may be used. This rare earth element oxide may contain a plurality of rare earth elements, for example, selected from the group consisting of Sc, Y, La, Nd, Sm, Gd, Dy, and Yb. Hereinafter, ZrO₂ in which a calcium oxide, a magnesium oxide, or a rare earth element oxide is in solid solution may be referred to as stabilized zirconia. Stabilized zirconia may include partially stabilized zirconia. The fuel electrode layer 5 is an example of the first electrode layer.

The solid electrolyte layer 6 is an electrolyte and delivers ions between the fuel electrode layer 5 and the air electrode layer 8. At the same time, the solid electrolyte layer 6 has gas blocking properties, and makes a leakage of the fuel gas and the oxygen-containing gas less likely to occur.

The solid electrolyte layer 6 contains zirconium (Zr) as the first material. The material of the solid electrolyte layer 6 may be, for example, ZrO₂ in which 3 mole % to 15 mole % of a rare earth element oxide is in solid solution. The rare earth element oxide may contain one or more rare earth elements, for example, selected from the group consisting of Sc, Y, La, Nd, Sm, Gd, Dy, and Yb. The solid electrolyte layer 6 may include, for example, ZrO₂ in which Yb, Sc, or Gd is in solid solution, or may include BaZrO₃ in which Sc or Yb is in solid solution. The solid electrolyte layer 6 is an example of the first member.

The intermediate layer 7 functions as a diffusion prevention layer. The intermediate layer 7 makes strontium (Sr) contained in the air electrode layer 8 less likely to diffuse into the solid electrolyte layer 6, thereby decreasing the possibility of forming a resistive layer of SrZrO₃ in such a solid electrolyte layer 6.

The intermediate layer 7 contains cerium (Ce) as the second material. The material of the intermediate layer 7 includes, for example, cerium oxide (CeO₂) in which a rare earth element except cerium (Ce) is in solid solution. As such rare earth elements, gadolinium (Gd), samarium (Sm), or the like may be used. The intermediate layer 7 is an example of the second member.

The air electrode layer 8 has gas permeability. The open porosity of the air electrode layer 8 may be, for example, 20% or more, and particularly may be in a range from 30% to 50%.

The material of the air electrode layer 8 is not particularly limited as long as the material is commonly used for air electrodes. The material of the air electrode layer 8 may be, for example, an electrically conductive ceramic such as a so-called ABO₃ type perovskite oxide.

The material of the air electrode layer 8 may be, for example, a composite oxide in which strontium (Sr) and lanthanum (La) coexist in the A-site. Examples of such a composite oxide include LaₓSr₁₋ₓCo_{y}Fe_{1-y}O₃, LaₓSr₁₋ₓMnO₃, LaₓSr₁₋ₓFeO₃, and LaₓSr₁₋ₓCoO₃. Here, x is 0<x<1, and y is 0<y<1. The air electrode layer 8 is an example of the second electrode layer.

The interconnector 4 is dense, and decreases the possibility of leakage of the fuel gas flowing through the gas-flow passages 2a located inside the support substrate 2, as well as the leakage of the oxygen-containing gas flowing outside the support substrate 2. The interconnector 4 may have a relative density of 93% or more, particularly 95% or more.

As the material of the interconnector 4, a lanthanum chromite-based perovskite oxide (LaCrO₃-based oxide), a lanthanum strontium titanium-based perovskite oxide (LaSrTiO₃-based oxide), or the like may be used. These materials have electrical conductivity, and are unlikely to be reduced and also unlikely to be oxidized even when brought into contact with a fuel gas such as a hydrogen-containing gas and an oxygen-containing gas such as air.

The element portion 3 also includes a boundary portion 9 located between the solid electrolyte layer 6 and the intermediate layer 7. Details of the boundary portion 9 will be described later.

### Configuration of Electrochemical Cell Device

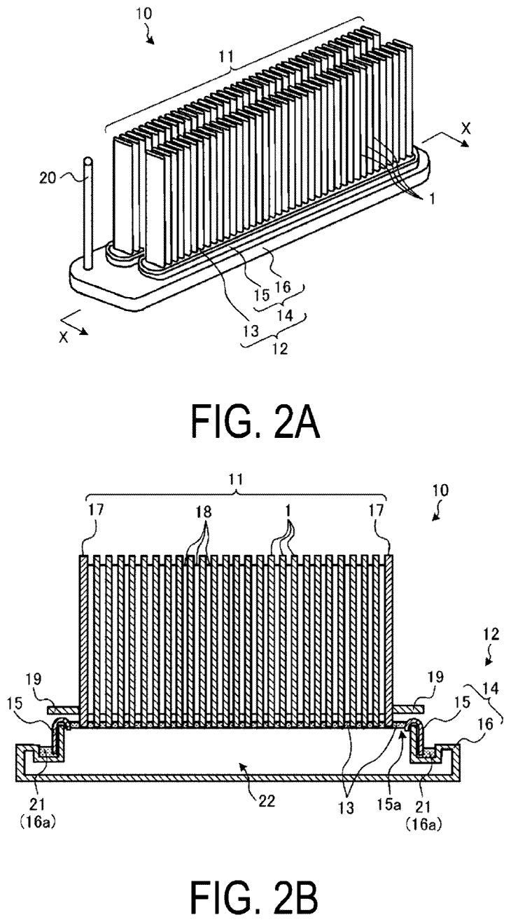

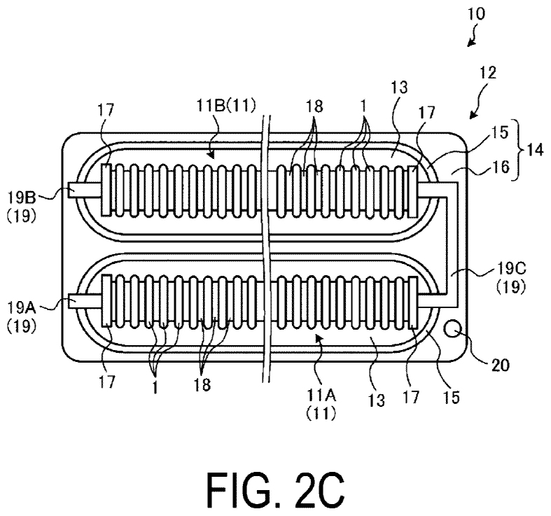

An electrochemical cell device according to the present embodiment using the cell 1 described above will be described with reference to FIGS. 2A to 2C. FIG. 2A is a perspective view illustrating an example of an electrochemical cell device according to the first embodiment. FIG. 2B is a cross-sectional view taken along a line X-X illustrated in FIG. 2A. FIG. 2C is a top view illustrating an example of the electrochemical cell device according to the first embodiment.

As illustrated in FIG. 2A, a cell stack device 10 includes a cell stack 11 including a plurality of the cells 1 arrayed (stacked) in the thickness direction T of each cell 1, and a fixing member 12 (see FIG. 1A).

The fixing member 12 includes a fixing material 13 and a support member 14. The support member 14 supports the cells 1. The fixing material 13 fixes the cells 1 to the support member 14. The support member 14 includes a support body 15 and a gas tank 16. The support body 15 and the gas tank 16, which constitute the support member 14, are made of metal.

As illustrated in FIG. 2B, the support body 15 includes an insertion hole 15a into which the lower end portions of the plurality of cells 1 are inserted. The lower end portions of the plurality of cells 1 and the inner wall of the insertion hole 15a are bonded with the fixing material 13.

The gas tank 16 includes an opening portion through which a reactive gas is supplied to the plurality of cells 1 via the insertion hole 15a, and a recessed groove 16a located on the periphery of the opening portion. The outer peripheral end portion of the support body 15 is bonded to the gas tank 16 with a bonding material 21 filled in the recessed groove 16a of the gas tank 16.

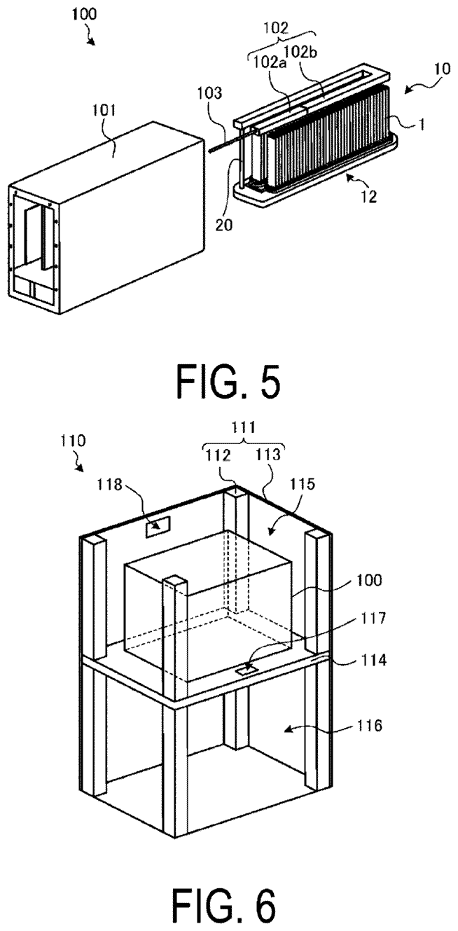

In the example illustrated in FIG. 2A, the fuel gas is stored in an internal space 22 formed by the support body 15 and the gas tank 16 which constitute the support member 14. The gas tank 16 includes a gas circulation pipe 20 connected thereto. The fuel gas is supplied to the gas tank 16 through the gas circulation pipe 20 and is supplied from the gas tank 16 to the gas-flow passages 2a (see FIG. 1A) inside the cells 1. The fuel gas supplied to the gas tank 16 is produced by a reformer 102 (see FIG. 5) which will be described later.

A hydrogen-rich fuel gas can be produced, for example, by steam-reforming a raw fuel. When the fuel gas is produced by steam-reforming, the fuel gas contains steam.

In the example illustrated in FIG. 2A, two rows of the cell stacks 11, two support bodies 15, and the gas tank 16 are provided. Each of the two rows of the cell stacks 11 includes the plurality of cells 1. Each of the cell stacks 11 is fixed to a corresponding one of the support bodies 15. An upper surface of the gas tank 16 has two through holes. Each of the support bodies 15 is disposed in a corresponding one of the through holes. The internal space 22 is constituted by a single gas tank 16 and two support bodies 15.

The insertion hole 15a has, for example, an oval shape in a top view. For example, the length of the insertion hole 15a in an arrangement direction of the cells 1, that is, the thickness direction T, is longer than the distance between two end current collection members 17 located at both ends of the cell stack 11. The width of the insertion hole 15a is, for example, greater than the length of the cell 1 in the width direction W (see FIG. 1A).

As illustrated in FIG. 2B, the bonded portions between the inner wall of the insertion hole 15a and the lower end portions of the cells 1 are filled with the fixing material 13 and solidified. As a result, the inner wall of the insertion hole 15a and the lower end portions of the plurality of cells 1 are bonded and fixed, and the lower end portions of the cells 1 are bonded and fixed to each other. The gas-flow passages 2a of each of the cells 1 communicate, at the lower end portion, with the internal space 22 of the support member 14.

The fixing material 13 and the bonding material 21 may be made of a material such as glass having a low electrical conductivity. As the specific material of the fixing material 13 and the bonding material 21, amorphous glass or the like may be used, and especially, crystallized glass or the like may be used.

As the crystallized glass, for example, any material selected from the group consisting of SiO₂—CaO-based, MgO—B₂O₃-based, La₂O₃—B₂O₃—MgO-based, La₂O₃—B₂O₃—ZnO-based, and SiO₂—CaO—ZnO-based materials may be used. In particular, an SiO₂—MgO-based material may be used.

As illustrated in FIG. 2B, a connecting member 18 is interposed between adjacent cells 1 of the plurality of cells 1. Each of the connecting members 18 electrically connects, in series, the fuel electrode layer 5 of one of adjacent ones of the cells 1 with the air electrode layer 8 of the other of the adjacent ones of the cells 1. More specifically, each of the connecting members 18 connects the interconnector 4 electrically connected to the fuel electrode layer 5 of one of the adjacent ones of the cells 1 and the air electrode layer 8 of the other of the adjacent ones of the cells 1.

As illustrated in FIG. 2B, the end current collection members 17 are electrically connected to the cells 1 located at the outermost sides in the arrangement direction of the plurality of cells 1. The end current collection members 17 are each connected to an electrically conductive portion 19 protruding outward from the cell stack 11. The electrically conductive portion 19 collects electricity generated by the cells 1 and conducts the electricity to the outside. Note that in FIG. 2A, the end current collection members 17 are not illustrated.

As illustrated in FIG. 2C, the cell stack device 10 may be a single battery in which two cell stacks 11A and 11B are connected in series. In such a case, the electrically conductive portion 19 of the cell stack device 10 is divided into a positive electrode terminal 19A, a negative electrode terminal 19B, and a connection terminal 19C.

The positive electrode terminal 19A functions as a positive electrode when the electrical power generated by the cell stack 11 is output to the outside, and is electrically connected to the end current collection member 17 on a positive electrode side in the cell stack 11A. The negative electrode terminal 19B functions as a negative electrode when the electrical power generated by the cell stack 11 is output to the outside, and is electrically connected to the end current collection member 17 on a negative electrode side in the cell stack 11B.

The connection terminal 19C electrically connects the end current collection member 17 on the negative electrode side in the cell stack 11A and the end current collection member 17 on the positive electrode side in the cell stack 11B.

### Details of Vicinity of Boundary Portion

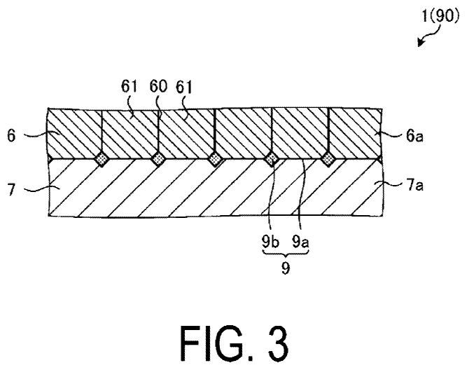

The solid electrolyte layer 6 and the intermediate layer 7 located at the boundary portion 9 and its vicinity according to the first embodiment will be described with reference to FIG. 3. FIG. 3 is a cross-sectional view illustrating an example of the vicinity of the boundary portion illustrated in FIG. 1A.

As illustrated in FIG. 3, the cell 1 includes the boundary portion 9 located between the solid electrolyte layer 6 as the first member and the intermediate layer 7 as the second member. Such a structure may be configured as a composite member 90 including the solid electrolyte layer 6 as the first member, the intermediate layer 7 as the second member, and the boundary portion 9. Such a composite member 90 may include the fuel electrode layer 5 or the air electrode layer 8.

The solid electrolyte layer 6 contains a first material 6a. The solid electrolyte layer 6 is polycrystalline and includes a plurality of crystal particles 61. The plurality of crystal particles 61 are partitioned by a grain boundary 60. Although FIG. 3 only illustrates the crystal particles 61 located along the boundary portion 9, that is, those in contact with the boundary portion, the solid electrolyte layer 6 may also have a plurality of crystal particles 61 in the thickness direction.

The boundary portion 9 contains the first material 6a and a second material 7a. The boundary portion 9 may contain, for example, ZrO₂ and CeO₂, or a solid solution of ZrO₂ and CeO₂.

The boundary portion 9 is a portion in which the ratio of the first material 6a relative to the total sum of the first material 6 a and the second material 7 a is in a range from 20% to 80%.

The boundary portion 9 includes a first portion 9a and a second portion 9b. The second portion 9b is thicker than the first portion 9a.

For example, a region where the thickness of the boundary portion 9 is 0.2 μm or less can be defined as the first portion 9a, and the other regions can be defined as the second portion 9 b. Alternatively, a portion in which the thickness of the boundary portion 9 is 0.4 μm or more may be defined as the second portion 9b, and the other portions may be defined as the first portion 9a. The first portion 9a may have substantially zero thickness. That is, the first portion 9a may be an interface between the solid electrolyte layer 6 and the intermediate layer.

Since the boundary portion 9 located between the solid electrolyte layer 6 and the intermediate layer 7 includes the first portion 9a and the second portion 9b having different thicknesses, the performance of the cell 1 is improved. For example, in the thin first portion 9a, the electrical conductivity between the solid electrolyte layer 6 and the intermediate layer 7 is ensured via the thin boundary portion 9, whereby the power generation capability is improved. On the other hand, for example, in the second portion 9b thicker than the first portion 9a, the bonding strength between the solid electrolyte layer 6 and the intermediate layer 7 is ensured via the thick boundary portion 9, whereby the durability is improved. Although FIG. 3 illustrates the case in which the second portion 9b has a thickness on both the solid electrolyte layer 6 side and the intermediate layer 7 side, the second portion 9b may have a thickness biased toward either the solid electrolyte layer 6 side or the intermediate layer 7 side.

Note that the thickness of the boundary portion 9 including the first material 6a and the second material 7a can be measured, for example, by using a scanning electron microscope (SEM), or a transmission electron microscope (TEM), and an energy dispersive X-ray analyzer (EDX) to examine the cross-section of the element portion 3 including the solid electrolyte layer 6 and the intermediate layer 7. Specifically, a cross-section of the element portion 3 or the composite member 90 in the layering direction is mirror-polished, and Zr contained in first material 6a and Ce contained in second material 7a are semi-quantitatively analyzed in a predetermined area including the solid electrolyte layer 6 and the intermediate layer 7. Using the analysis results obtained, the first portion 9a and the second portion 9b of the boundary portion 9 can be identified by converting the content per unit area to atomic % units.

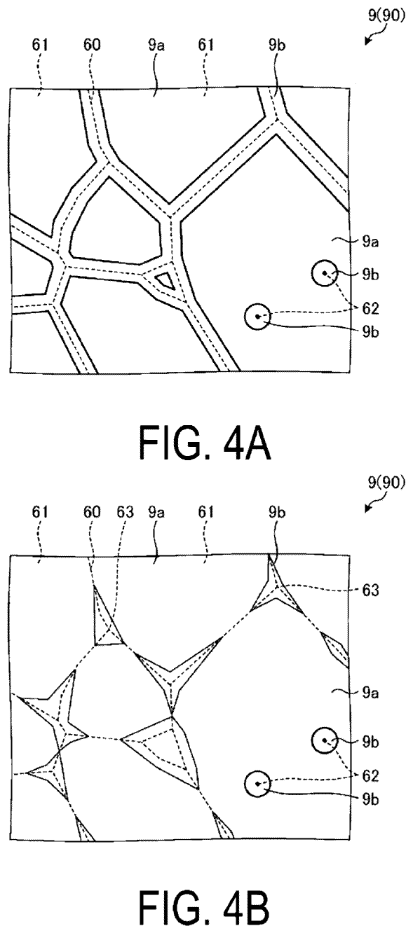

The distribution of the first portion 9a and the second portion 9b included in the boundary portion 9 will be described with reference to FIGS. 4A and 4B. FIG. 4A is a plan view illustrating an example of the boundary portion illustrated in FIG. 3. FIG. 4B is a plan view illustrating another example of the boundary portion illustrated in FIG. 3.

As illustrated in FIG. 4A, the second portion 9b of the boundary portion 9 may be located continuously in a mesh pattern so as to overlap, in a plan view, the grain boundary 60 that is in contact with the boundary portion 9 of the grain boundary 60 partitioning the plurality of crystal particles 61. For example, the second portion 9b may be located so as to overlap a defect 62 such as oxygen deficiency of the crystal particles 61 in a plan view.

The first portion 9a is located in a region where the second portion 9b is not located in a plan view. The first portion 9a may be located in an island pattern so as to overlap, in a plan view, at least one crystal particle 61 among a plurality of crystal particles 61 that are in contact with the boundary portion 9.

As illustrated in FIG. 4B, the second portion 9b of the boundary portion 9 may be located in an island pattern so as to overlap, in a plan view, a triple point 63 of the grain boundary 60 partitioning the plurality of crystal particles 61. The shape of the second portion 9b in a plan view is not limited to the shapes illustrated in FIGS. 4A and 4B, and may be any shape such as an arc shape, a linear shape, a Y shape, a cross shape, a star shape, or a tree shape, or may be a mixture shape thereof. The shape of the second portion 9b in a plan view may be an interrupted mesh shape.

As described above, since the first portion 9a and the second portion 9b having different thicknesses are distributed in the boundary portion 9 that is in contact with the solid electrolyte layer 6 and the intermediate layer 7, a desired electrical conductivity and bonding strength can be ensured, whereby the performance is improved.

The composite member 90 as described above in which the first portion 9a and the second portion 9b are distributed in the boundary portion 9 that is in contact with the solid electrolyte layer 6 and the intermediate layer 7 can be obtained by, for example, applying a sintering aid such as cobalt oxide or copper oxide to the solid electrolyte layer 6, drying it, and providing and sintering an intermediate layer material. For example, the sintering aid may be applied to a thickness of 10 nm or less. The sintering aid applied to the surface of the solid electrolyte layer 6 makes it easier to form the solid solution of the first material 6a and the second material 7a. The boundary portion 9 including the first portion 9a and the second portion 9b is obtained due to a different magnitude of such a reaction with the sintering aid on the crystal particles 61 and on the grain boundary 60. Such a structure of the composite member may be formed by providing the intermediate layer 7 on the surface of the solid electrolyte layer 6 by epitaxial growth. However, the method of forming the composite member 90 is not limited and may be formed by any method. The intermediate layer 7 may be polycrystalline similar to the solid electrolyte layer 6. In that case, the intermediate layer 7 may have a crystal structure corresponding to that of the solid electrolyte layer 6 facing the intermediate layer 7 across the boundary portion 9. In other words, the crystal particles and the grain boundary that are in contact with the boundary portion 9 among the plurality of crystal particles and the grain boundary constituting the intermediate layer 7 may be positioned so as to overlap, in a plan view, the crystal particles 61 and the grain boundary 60 that are in contact with the boundary portion 9 among the plurality of crystal particles 61 and the grain boundary 60 of the solid electrolyte layer 6. The intermediate layer 7 may have pores. The intermediate layer 7 may have a porosity greater than that of the solid electrolyte layer 6 and the boundary portion 9.

### Module

A module according to an embodiment of the present disclosure using the electrochemical cell device described above will be described with reference to FIG. 5. FIG. 5 is an exterior perspective view illustrating the module according to the first embodiment. FIG. 5 illustrates a state in which front and rear surfaces being a part of a storage container 101 are removed and the cell stack device 10 of the fuel cell stored in the container is taken out rearward.

As illustrated in FIG. 5, a module 100 includes a storage container 101 and a cell stack device 10 stored therein. The reformer 102 is disposed above the cell stack device 10.

The reformer 102 generates a fuel gas by reforming a raw fuel such as natural gas and kerosene and supplies the fuel gas to the cell 1. The raw fuel is supplied to the reformer 102 through a raw fuel supply pipe 103. Note that the reformer 102 may include a vaporizing unit 102a for vaporizing water and a reforming unit 102b. The reforming unit 102b includes a reforming catalyst (not illustrated) to reform the raw fuel into a fuel gas. Such a reformer 102 can perform steam-reforming which is a highly efficient reformation reaction.

The fuel gas generated by the reformer 102 is supplied to the gas-flow passages 2a of the cell 1 (see FIG. 1A) through the gas circulation pipe 20, the gas tank 16, and the support member 14.

In the module 100 having the configuration mentioned above, the temperature in the module 100 during normal power generation is from about 500° C. to 1000° C. due to combustion of gas and power generation by the cells 1.

In such a module 100, as described above, the module 100 with improved power generation capability can be provided by housing the cell stack device 10 with the improved power generation capability.

### Module Housing Device

FIG. 6 is an exploded perspective view illustrating an example of a module housing device according to the first embodiment. A module housing device 110 according to the present embodiment includes an external case 111, the module 100 illustrated in FIG. 5, and an auxiliary device (not illustrated). The auxiliary device operates the module 100. The module 100 and the auxiliary device are housed in the external case 111. Note that FIG. 6 does not illustrate some components.

The external case 111 of the module housing device 110 illustrated in FIG. 6 includes supports 112 and external plates 113. A dividing plate 114 vertically partitions the interior of the external case 111. The space above the dividing plate 114 in the external case 111 is a module housing chamber 115 for housing the module 100. The space below the dividing plate 114 in the external case 111 is an auxiliary device housing chamber 116 for housing the auxiliary device configured to operate the module 100. Note that FIG. 6 does not illustrate the auxiliary device housed in the auxiliary device housing chamber 116.

The dividing plate 114 has an air circulation hole 117 for causing air in the auxiliary device housing chamber 116 to flow to the module housing chamber 115 side. The external plate 113 constituting the module housing chamber 115 has an exhaust hole 118 for discharging air inside the module housing chamber 115.

In such a module housing device 110, as described above, the module 100 with the improved performance is provided in the module housing chamber 115, thus providing the module housing device 110 with the improved performance.

Note that the embodiment described above has exemplified the case in which the support substrate of the hollow flat plate-shaped is used, but the embodiment can also be applied to an electrochemical cell device using a cylindrical support substrate.

### Second Embodiment

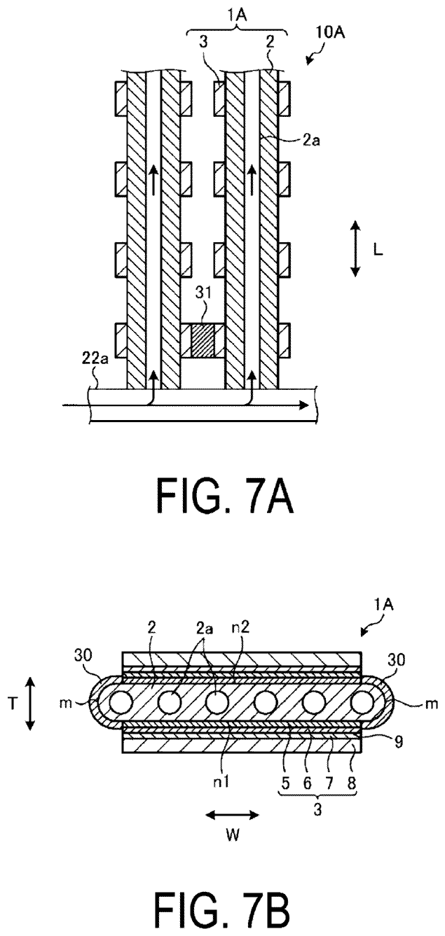

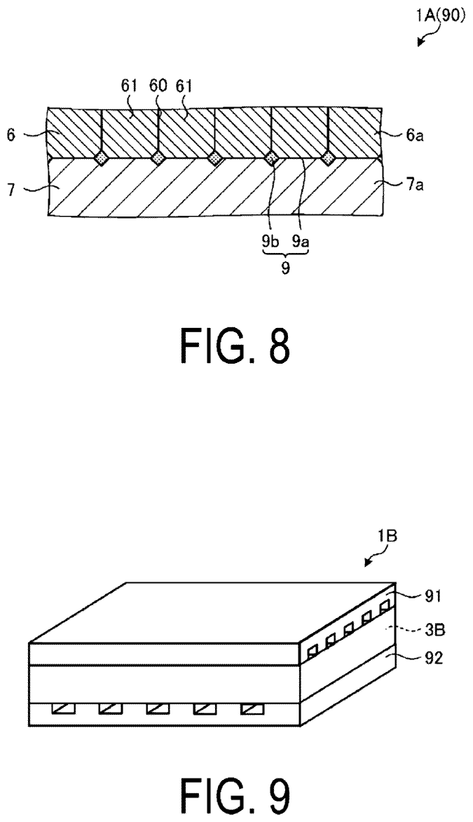

An electrochemical cell and an electrochemical cell device according to a second embodiment will be described with reference to FIGS. 7A to 8.

In the embodiment described above, a so-called “vertically striped type” cell stack device, in which only one element portion including a fuel electrode, a solid electrolyte layer, and an air electrode is provided on the surface of the support substrate, is exemplified. However, the present disclosure can be applied to a horizontally striped type electrochemical cell device with an array of so-called “horizontally striped type” electrochemical cells, in which a plurality of element portions are provided on the surface of a support substrate at mutually separated locations and adjacent element portions are electrically connected to each other.

FIG. 7A is a cross-sectional view illustrating an example of the electrochemical cell device according to a second embodiment, FIG. 7B is a horizontal cross-sectional view illustrating an electrochemical cell according to the second embodiment, and FIG. 8 is a cross-sectional view illustrating an example of the vicinity of the boundary portion illustrated in FIG. 7B.

As illustrated in FIG. 7A, a cell stack device 10A includes a plurality of cells 1A extending in the length direction L from a pipe 22a that distributes a fuel gas. Each of the cells 1A includes a plurality of the element portions 3 on the support substrate 2. Gas-flow passages 2a, through which a fuel gas from the pipe 22a flows, are provided inside the support substrate 2.

The cells 1A are electrically connected to each other via connecting members 31. Each of the connecting members 31 is located between the element portions 3 each included in a corresponding one of the cells 1A and electrically connects adjacent ones of the cells 1A to each other.

As illustrated in FIG. 7B, the cell 1A according to the second embodiment includes the support substrate 2, a pair of the element portions 3, and a sealing portion 30. The support substrate 2 has a pillar shape having a first surface n1 and a second surface n2 which are a pair of flat surfaces facing each other, and a pair of circular arc-shaped side surfaces m that connect the first surface n1 and the second surface n2.

The pair of element portions 3 is located on the first surface n1 and the second surface n2 of the support substrate 2 so as to face each other. The sealing portion 30 is located to cover the side surfaces m of the support substrate 2.

As illustrated in FIG. 8, the cell 1A includes the boundary portion 9 located between the solid electrolyte layer 6 as the first member and the intermediate layer 7 as the second member. Such a structure may be configured as the composite member 90 including the solid electrolyte layer 6, the intermediate layer 7, and the boundary portion 9.

The solid electrolyte layer 6 contains the first material 6a. The solid electrolyte layer 6 is polycrystalline and includes the plurality of crystal particles 61. The plurality of crystal particles 61 are partitioned by a grain boundary 60.

The boundary portion 9 contains the first material 6a and a second material 7a. The boundary portion 9 may contain, for example, ZrO₂ and CeO₂, or a solid solution of ZrO₂ and CeO₂.

The boundary portion 9 includes the first portion 9a and the second portion 9b. The second portion 9b is thicker than the first portion 9a.

As described above, the boundary portion 9 located between the solid electrolyte layer 6 and the intermediate layer 7 includes the first portion 9a and the second portion 9b having different thicknesses, whereby the performance of the cell 1A is improved. For example, in the first portion 9a, the electrical conductivity between the solid electrolyte layer 6 and the intermediate layer 7 is ensured via the thin boundary portion 9, whereby the power generation capability is improved. On the other hand, for example, in the second portion 9b thicker than the first portion 9a, the bonding strength between the solid electrolyte layer 6 and the intermediate layer 7 is ensured via the thick boundary portion 9, whereby the durability is improved.

### Third Embodiment

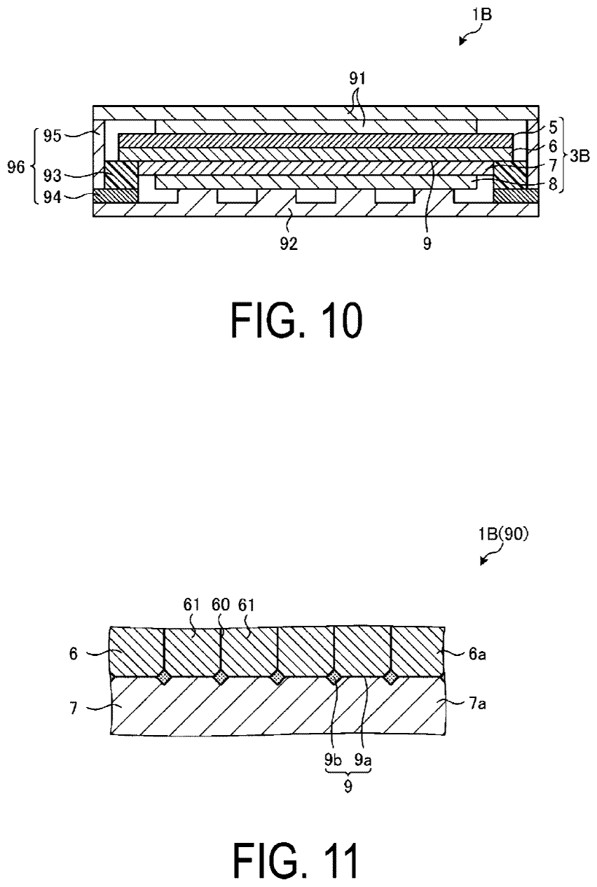

FIG. 9 is a perspective view illustrating an example of an electrochemical cell according to a third embodiment. FIG. 10 is a partial cross-sectional view of the electrochemical cell illustrated in FIG. 9.

As illustrated in FIGS. 9 and 10, a cell 1B includes an element portion 3B, in which the fuel electrode layer 5, the solid electrolyte layer 6, the intermediate layer 7, and the air electrode layer 8 are layered, and the electrically conductive members 91, 92. The boundary portion 9 is located between the solid electrolyte layer 6 and the intermediate layer 7. In an electrochemical cell device in which a plurality of flat plate cells are layered, for example, a plurality of cells 1B are electrically connected by electrically conductive members 91 and 92, which are metal layers adjacent to each other. The electrically conductive members 91 and 92 electrically connect adjacent ones of the cells 1B to each other, and each include gas-flow passages for supplying gas to the fuel electrode layer 5 or the air electrode layer 8.

As illustrated in FIG. 10, the cell 1B includes a sealing material for hermetically sealing the flow passage of a fuel gas and the flow passage of an oxygen-containing gas in the flat plate cell stack. The sealing material is a fixing member 96 of the cell, and includes a bonding material 93 and support members 94 and 95 constituting a frame. The bonding material 93 may be a glass or may be a metal material such as silver solder.

The support member 94 may be a so-called separator that separates the flow passage of the fuel gas and the flow passage of the oxygen-containing gas. The material of the support members 94 and 95 may be, for example, an electrically conductive metal, or may be an insulating ceramic. When the support member 94 is a metal member, the support member 94 may be formed integrally with the electrically conductive member 92. When the support member 95 is a metal member, the support member 95 may be formed integrally with the electrically conductive member 91.

One of the bonding material 93 and the support members 94 and 95 has insulating properties and causes the two electrically conductive members 91 and 92 sandwiching the flat plate cell to be electrically insulated from each other.

FIG. 11 is an enlarged cross-sectional view illustrating an example of the vicinity of the boundary portion illustrated in FIG. 10. As illustrated in FIG. 11, the cell 1B has the boundary portion 9 located between the solid electrolyte layer 6 as the first member and the intermediate layer 7 as the second member. Such a structure may be configured as the composite member 90 including the solid electrolyte layer 6, the intermediate layer 7, and the boundary portion 9.

The solid electrolyte layer 6 contains the first material 6a. The solid electrolyte layer 6 is polycrystalline and includes a plurality of crystal particles 61. The plurality of crystal particles 61 are partitioned by a grain boundary 60.

The boundary portion 9 contains the first material 6a and a second material 7a. The boundary portion 9 may contain, for example, ZrO₂ and CeO₂, or a solid solution of ZrO₂ and CeO₂.

The boundary portion 9 includes the first portion 9a and the second portion 9b. The second portion 9b is thicker than the first portion 9a.

As described above, the boundary portion 9 located between the solid electrolyte layer 6 and the intermediate layer 7 includes the first portion 9a and the second portion 9b having different thicknesses, whereby the performance of the cell 1B is improved. For example, in the first portion 9a, the electrical conductivity between the solid electrolyte layer 6 and the intermediate layer 7 is ensured via the thin boundary portion 9, whereby the power generation capability is improved. On the other hand, for example, in the second portion 9b which is thicker than the first portion 9a, the bonding strength between the solid electrolyte layer 6 and the intermediate layer 7 via the boundary portion 9 is ensured, whereby the durability is improved.

### Fourth Embodiment

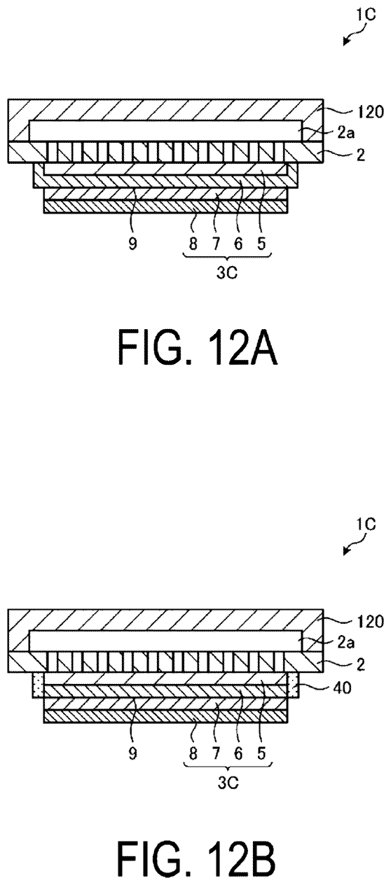

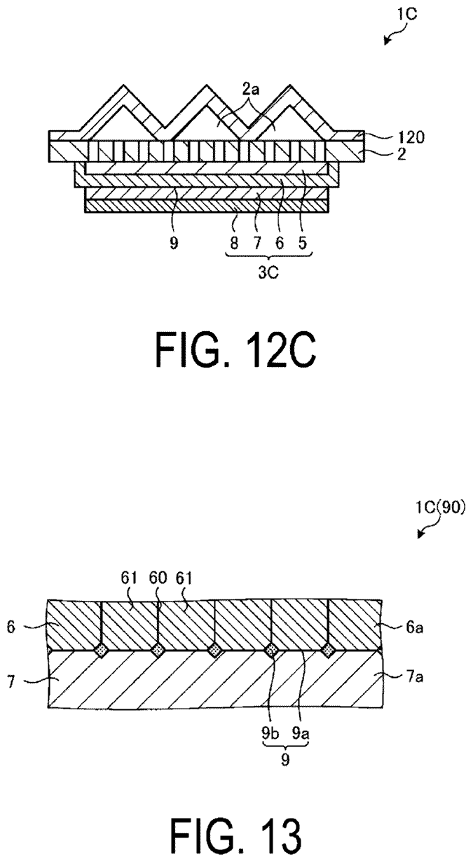

FIG. 12A is a horizontal cross-sectional view illustrating an example of an electrochemical cell according to a fourth embodiment. FIGS. 12B and 12C are horizontal cross-sectional views illustrating another example of the electrochemical cell according to the fourth embodiment. FIG. 13 is a cross-sectional view illustrating an example of the vicinity of the boundary portion illustrated in FIG. 12A. Note that FIG. 13 can also be applied to the examples of FIGS. 12B and 12C.

As illustrated in FIGS. 12A to 12C, a cell 1C includes an element portion 3C in which the fuel electrode layer 5, the solid electrolyte layer 6, the intermediate layer 7, and the air electrode layer 8 are layered, and the support substrate 2. The boundary portion 9 is located between the solid electrolyte layer 6 and the intermediate layer 7. The support substrate 2 has through holes or fine holes at a site that is in contact with the element portion 3, and includes a member 120 located outside the gas-flow passage 2a. The support substrate 2 allows gas to flow between the gas-flow passage 2a and the element portion 3C. The support substrate 2 may be made of, for example, one or more metal plates. A material of the metal plate may contain chromium. The metal plate may include an electrically conductive coating layer. The support substrate 2 electrically connects adjacent ones of the cells 1C to each other. The element portion 3C may be directly formed on the support substrate 2 or may be bonded to the support substrate 2 with a bonding material.

In the example illustrated in FIG. 12A, the side surface of the fuel electrode layer 5 is coated with the solid electrolyte layer 6 to hermetically seal the gas-flow passage 2a through which the fuel gas flows. As illustrated in FIG. 12B, the side surface of the fuel electrode layer 5 may be coated with dense glass or a ceramic sealing material 40 and sealed. The sealing material 40 coating the side surface of the fuel electrode layer 5 may have electrical insulation.

The gas-flow passage 2a of the support substrate 2 may be made of the member 120 having unevenness as illustrated in FIG. 12C.

As illustrated in FIG. 13, the cell 1C includes the boundary portion 9 located between the solid electrolyte layer 6 as the first member and the intermediate layer 7 as the second member. Such a structure may be configured as the composite member 90 including the solid electrolyte layer 6, the intermediate layer 7, and the boundary portion 9.

The solid electrolyte layer 6 contains the first material 6a. The solid electrolyte layer 6 is polycrystalline and includes the plurality of crystal particles 61. The plurality of crystal particles 61 are partitioned by a grain boundary 60.

The boundary portion 9 contains the first material 6a and the second material 7a. The boundary portion 9 may contain, for example, ZrO₂ and CeO₂, or a solid solution of ZrO₂ and CeO₂.

The boundary portion 9 includes the first portion 9a and the second portion 9b. The second portion 9b is thicker than the first portion 9a.

As described above, the boundary portion 9 located between the solid electrolyte layer 6 and the intermediate layer 7 includes the first portion 9a and the second portion 9b having different thicknesses, whereby the performance of the cell 1C is improved. For example, in the first portion 9a, the electrical conductivity between the solid electrolyte layer 6 and the intermediate layer 7 is ensured via the thin boundary portion 9, whereby the power generation capability is improved. On the other hand, for example, in the second portion 9b thicker than the first portion 9a, the bonding strength between the solid electrolyte layer 6 and the intermediate layer 7 is ensured via the thick boundary portion 9, whereby the durability is improved.

### Other Embodiments

An electrochemical cell device according to other embodiments will be described.

In the above embodiments, a fuel cell, a fuel cell stack device, a fuel cell module, and a fuel cell device are illustrated as examples of the “electrochemical cell”, the “electrochemical cell device”, the “module”, and the “module housing device”, respectively, but in other examples, they may be provided as an electrolyte cell, an electrolyte cell stack device, an electrolyte module, and an electrolyte device. The electrolytic cell includes a first electrode layer and a second electrode layer, and decomposes water vapor into hydrogen and oxygen or decomposes carbon dioxide into carbon monoxide and oxygen by supplying electric power. Although an oxide ion conductor or a hydrogen ion conductor is illustrated as an example of the electrolyte material of the electrochemical cell in each of the above embodiments, the electrolyte material may be a hydroxide ion conductor. Such an electrolytic cell, an electrolytic cell stack device, an electrolytic module, and an electrolytic device can have the improved electrolytic performance and durability.

While the present disclosure has been described in detail, the present disclosure is not limited to the aforementioned embodiments, and various changes, improvements, and the like can be made without departing from the gist of the present disclosure.

In an embodiment, (1) a composite member includes
a polycrystalline first member containing a first material,
a second member containing a second material different from the first material, and
a boundary portion located between the first member and the second member and containing the first material and the second material,
in which the boundary portion includes a first portion and a second portion thicker than the first portion.
(2) In the composite member as recited in (1) above,
   the first portion may be located in a manner to overlap, in a plan view, at least one crystal particle that is in contact with the contact the boundary portion among a plurality of crystal particles of the first member.
(3) In the composite member as recited in (1) or (2) above,
   the second portion may be located in a manner to overlap, in a plan view, at least a part of a grain boundary that is in contact with the boundary portion of grain boundaries located between the plurality of crystal particles of the first member.
(4) In the composite member as recited in any one of (1) to (3) above,
   the boundary portion may contain a solid solution of the first material and the second material.
(5) In the composite member as recited in any one of (1) to (4) above,
   the second member may have a crystal structure corresponding to the first material facing the second member across the boundary portion.
(6) An electrochemical cell includes
   the composite member as recited in any one of (1) to (5) above, and a first electrode layer and a second electrode layer facing each other across the composite member.
(7) An electrochemical cell device includes a cell stack including the electrochemical cell as recited in (6) above.
(8) A module includes
   the electrochemical cell device as recited in (7) above, and
   a storage container housing the electrochemical cell device.
(9) A module housing device includes
   the module as recited in (8) above,
   an auxiliary device configured to operate the module, and
   an external case housing the module and the auxiliary device.

Note that the embodiments disclosed herein are exemplary in all respects and not restrictive. The aforementioned embodiments can be embodied in a variety of forms. The above-described embodiments may be omitted, substituted or modified in various forms without departing from the scope and spirit of the appended claims.

### REFERENCE SIGNS

1, 1A to 1C Cell
2 Support substrate
3, 3B, 3C Element portion
4 Interconnector
5 Fuel electrode layer
6 Solid electrolyte layer
6a First material
7 Intermediate layer
7a Second material
8 Air electrode layer
9 Boundary portion
9a First portion
9b Second portion
10 Cell stack device
11 Cell stack
12 Fixing member
13 Fixing material
14 Support member
15 Support body
16 Gas tank
17 End current collection member
18 Connecting member
100 Module
110 Module housing device

1. A composite member, comprising:
a polycrystalline first member containing a first material;
a second member containing a second material different from the first material; and
a boundary portion located between the first member and the second member and containing the first material and the second material,
wherein the boundary portion comprises a first portion and a second portion thicker than the first portion.

2. The composite member according to claim 1,
wherein the first portion is located in a manner to overlap, in a plan view, at least one crystal particle that is in contact with the boundary portion among a plurality of crystal particles of the first member.

3. The composite member according to claim 1,
wherein the second portion is located in a manner to overlap, in a plan view, at least a part of a grain boundary that is in contact with the boundary portion of grain boundaries located between the plurality of crystal particles of the first member.

4. The composite member according to claim 1,
wherein the boundary portion contains a solid solution of the first material and the second material.

5. The composite member according to claim 1,
wherein the second member has a crystal structure corresponding to the first material facing the second member across the boundary portion.

6. An electrochemical cell comprising:
the composite member according to claim and
a first electrode layer and a second electrode layer facing each other across the composite member.

7. An electrochemical cell device comprising:
a cell stack comprising the electrochemical cell according to claim 6.

8. A module comprising:
the electrochemical cell device according to claim 7; and
a storage container housing the electrochemical cell device.

9. A module housing device comprising:
the module according to claim 8;
an auxiliary device configured to operate the module; and
an external case housing the module and the auxiliary device.
